(19) United States
(12) Patent Application Publication
(10) Pub. No.: US 2019/0256774 A1
(43) Pub. Date: Aug. 22, 2019

(54) LIQUID CRYSTAL COMPOSITION AND LIQUID CRYSTAL HIGH FREQUENCY ANTENNA

(71) Applicants: JNC CORPORATION, Tokyo (JP); JNC PETROCHEMICAL CORPORATION, Tokyo (JP)

(72) Inventors: Yasuhiro KUBO, CHIBA (JP); Yasutomo NAGANO, CHIBA (JP)

(73) Assignees: JNC CORPORATION, Tokyo (JP); JNC PETROCHEMICAL CORPORATION, Tokyo (JP)

(21) Appl. No.: 16/171,386

(22) Filed: Oct. 26, 2018

(30) Foreign Application Priority Data
Feb. 22, 2018 (JP) 2018-029944
Jun. 8, 2018 (JP) 2018-109984

(51) Int. Cl. C09K 19/34; C09K 19/30; H01Q 1/36

(52) U.S. Cl. CPC C09K 19/3444; C09K 19/3001; C09K 19/3068; C09K 19/3003; C09K 2019/301; H01Q 1/364; C09K 2019/3075; C09K 2019/3016; C09K 2019/3009; C09K 19/3059

(57) ABSTRACT

A liquid crystal composition that satisfies a plurality of characteristics in characteristics such as a high maximum temperature of a nematic phase, a low minimum temperature of the nematic phase, small viscosity, large optical anisotropy, large dielectric anisotropy (1 kHz and 20 GHz), large specific resistance, high stability to ultraviolet light and high stability to heat, and that can be used in the form of a millimeter wave phase or microwave phase antenna.

The liquid crystal composition contains at least two specific compounds having the large optical anisotropy and the large dielectric anisotropy as a first component, and a specific compound having a wide nematic phase and capable of adjusting suitable optical anisotropy as a second component, and may contain such a component compound that can finely control the characteristics of the composition.

### CROSS-REFERENCE TO RELATED APPLICATION

This application claims the priority benefit of Japan application no. 2018-029944, filed on Feb. 22, 2018, and Japan application no. 2018-109984, filed on Jun. 08, 2018. The entirety of each of the above-mentioned patent applications is hereby incorporated by reference herein and made a part of this specification.

### TECHNICAL FIELD

The invention relates mainly to a liquid crystal composition suitable for a millimeter wave phase or microwave phase antenna, and so forth, and a millimeter wave phase or microwave phase antenna including the composition, and so forth. The composition has a nematic phase and positive dielectric anisotropy.

### BACKGROUND ART

A millimeter wave phase or microwave phase antenna includes a liquid crystal composition having suitable characteristics. The liquid crystal composition has a nematic phase. In order to obtain the millimeter wave phase or microwave phase antenna having good general characteristics, general characteristics of the composition are improved. A temperature range of the nematic phase relates to a temperature range in which the millimeter wave phase or microwave phase antenna can be used. A preferred maximum temperature of the nematic phase is about 70° C. or higher, and a preferred minimum temperature of the nematic phase is about −10° C. or lower.

In a liquid crystal, alignment of molecules changes and a dielectric constant changes according to a bias electric field from an outside. If such properties are utilized, a microwave device in which transmission characteristics of a high frequency transmission line can be electrically controlled from the outside can be realized. With regard to such a device, a report has been made on a voltage-controlled millimeter wave band variable phase shifter in which a nematic liquid crystal is filled into a wave guide, a microwave/millimeter wave wide-band variable shifter in which a nematic liquid crystal is used as a dielectric substrate of a microstrip line, or the like.

A transmission delay time and an insertion loss thereof are measured by filling a liquid crystal into a coaxial line. Then, a dielectric constant of the liquid crystal and a dielectric loss of the liquid crystal are determined from the transmission delay time and the insertion loss, respectively. Here, a dielectric constant εr(∥) and a dielectric loss tan δ(∥) when the liquid crystals are in parallel with a microwave electric field, and a dielectric constant εr(⊥) and a dielectric loss tan δ(⊥) when the liquid crystals are perpendicular thereto can be measured by applying a bias voltage between a center conductor and an external conductor of the coaxial line and controlling alignment of the liquid crystal.

The composition that has been used so far is disclosed in Patent literature No. 1 to No. 3 described below.

Patent literature No. 1: JP H6-340878 A.

Patent literature No. 2: JP H7-300585 A.

Patent literature No. 3: JP 2014-529658 A.

A desirable high frequency antenna has characteristics such as a wide temperature range in which the device can be used, a high gain and a low loss (small dielectric loss tan δ of the liquid crystal) . Accordingly, desirable characteristics of the composition include a high maximum temperature of the nematic phase, a low minimum temperature of the nematic phase, large optical anisotropy, large dielectric anisotropy (1 kHz and 20 GHz), large specific resistance, high stability to ultraviolet light and high stability to heat, and so forth.

### SUMMARY OF INVENTION

### Technical Problem

The invention is to provide a liquid crystal composition satisfying a plurality of characteristics in characteristics such as a high maximum temperature of a nematic phase, a low minimum temperature of the nematic phase, small viscosity, large optical anisotropy, large dielectric anisotropy (1 kHz and 20 GHz), large specific resistance, high stability to ultraviolet light and high stability to heat. The invention is to provide a liquid crystal composition having a suitable balance with regard to the plurality of characteristics. The invention is also to provide a millimeter wave phase or microwave phase antenna including such a composition.

### Solution to Problem

The invention concerns a liquid crystal composition for a millimeter wave phase or microwave phase antenna, having a nematic phase, and containing at least two compounds selected from the group of compounds represented by formula (1-1) to formula (1-4) as a first component, wherein at least one compound selected from the compounds represented by formula (1-1) and at least one compound selected from the compounds represented by formula (1-3) are not simultaneously selected, and at least one compound selected from the group of compounds represented by formula (2-1) to formula (2-3) as a second component, and a millimeter wave phase or microwave phase antenna including the composition.

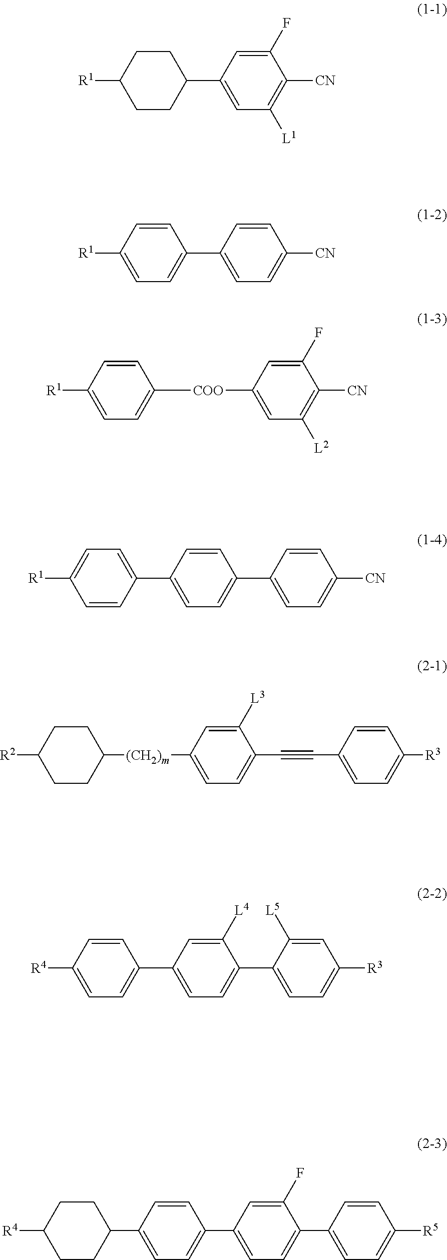

wherein, R¹, R², R³, R⁴ and R⁵ are independently alkyl having 1 to 7 carbons or alkenyl having 2 to 7 carbons, and L¹, L², L³, L⁴ and L⁵ are independently hydrogen or fluorine, and m is 0 or 2, in which one of L⁴ and L⁵ is fluorine, and the other is hydrogen.

### DESCRIPTION OF EMBODIMENTS

Usage of terms herein is as described below. A liquid crystal composition of the invention or a millimeter wave phase or microwave phase antenna of the invention may be occasionally abbreviated as “composition” or “high frequency antenna,” respectively. A term “liquid crystal compound” means a compound having a liquid crystal phase such as a nematic phase and a smectic phase or a compound having no liquid crystal phase but being useful as a component of the composition. The useful compound contains a six-membered ring such as 1,4-cyclohexylene and 1,4-phenylene, and has a linear molecular structure. An optically active compound may be occasionally added to the composition. Even if the compound is the liquid crystal compound, the compound is herein classified as an additive. At least one compound selected from the group of compounds represented by formula (1) may be occasionally abbreviated as “compound (1).” The group of compounds represented by formula (1) may be also occasionally abbreviated as “compound (1).” A same rule applies also to a compound represented by any other formula.

A maximum temperature of the nematic phase may be occasionally abbreviated as “maximum temperature.” A minimum temperature of the nematic phase may be occasionally abbreviated as “minimum temperature.” An expression “having large specific resistance” means that the composition has large specific resistance at room temperature and also at a high temperature in an initial stage, and the composition has the large specific resistance at room temperature and also at a high temperature even after the device has been used for a long period of time. When describing characteristics such as optical anisotropy, values measured according to methods described in Examples are used. A term “proportion of a first component” means weight percent (% by weight) based on the total weight of the liquid crystal compound. A same rule applies also to a proportion of a second component, and so forth. A proportion of the additive mixed with the composition means weight percent (% by weight) based on the total weight of the liquid crystal compound.

Compound (1-1) to compound (1-4) described below have large optical anisotropy and large dielectric anisotropy. The compound is preferred as a component of the composition for the millimeter wave phase or microwave phase antenna. Compound (1-1) is suitable for improving frequency characteristics rather than magnitude of the dielectric anisotropy, and compound (1-3) is suitable when the dielectric anisotropy is desired to be increased rather than improving the frequency characteristics. Compound (2-1) to compound (2-3) are selected, and the composition of the invention has been completed. Compound (2-1) to compound (2-3) have the wide nematic phase to allow suitable adjustment of the optical anisotropy, and compound (2-3) has the high maximum temperature. The composition having characteristics such as the large optical anisotropy, the large dielectric anisotropy, high reliability, the high maximum temperature and the low minimum temperature has been found by preparing the composition based on such a conception. A study has been further made on such a component compound that can finely adjust the characteristics of the composition, and the invention has been completed.

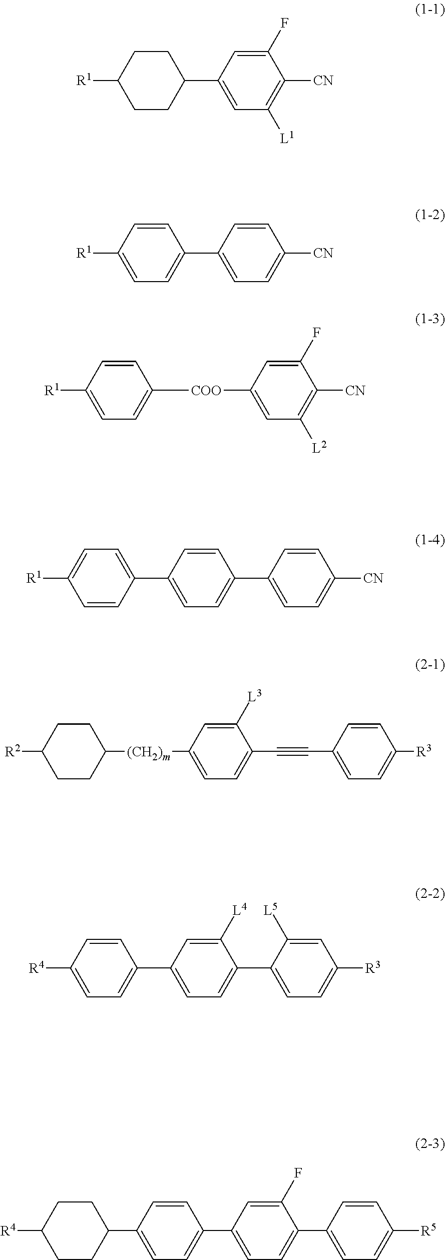

In which, R¹, R², R³, R⁴ and R⁵ are independently alkyl having 1 to 7 carbons or alkenyl having 2 to 7 carbons, and L¹, L², L³, L⁴ and L⁵ are independently hydrogen or fluorine, and m is 0 or 2, in which one of L⁴ and L⁵ is fluorine, and the other is hydrogen.

Details of the invention include items described below.

Item 1. A liquid crystal composition for a millimeter wave phase or microwave phase antenna, having a nematic phase, and containing at least two compounds selected from the group of compounds represented by formula (1-1) to formula (1-4) as a first component, wherein at least one compound selected from the compounds represented by formula (1-1) and at least one compound selected from the compounds represented by formula (1-3) are not simultaneously selected, and at least one compound selected from the group of compounds represented by formula (2-1) to formula (2-3) as a second component:

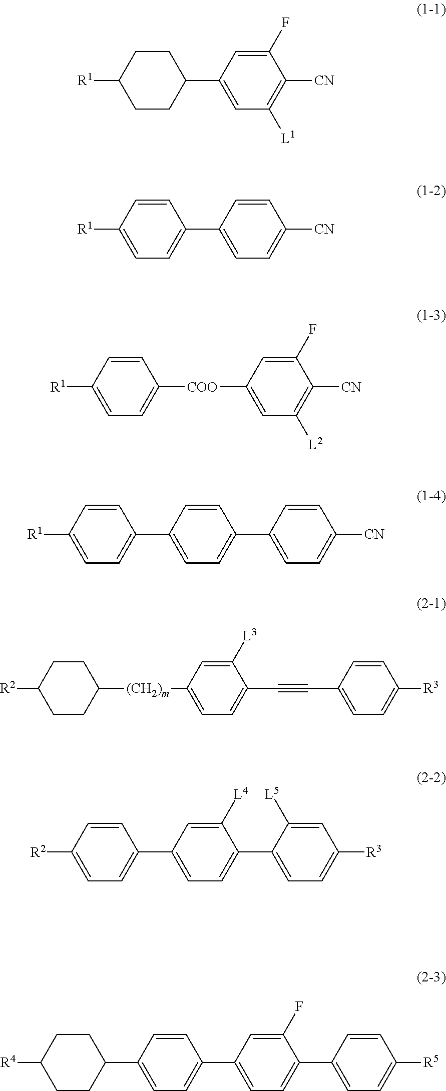

wherein, R¹, R², R³, R⁴ and R⁵ are independently alkyl having 1 to 7 carbons or alkenyl having 2 to 7 carbons, and L¹, L², L³, L⁴ and L⁵ are independently hydrogen or fluorine, and m is 0 or 2, in which one of L⁴ and L⁵ is fluorine, and the other is hydrogen.

Item 2. The liquid crystal composition according to item 1, wherein a proportion of the first component is in the range of 50% by weight to 95% by weight, and a proportion of the second component is in the range of 5% by weight to 50% by weight.

Item 3. The liquid crystal composition according to item 1 or 2, containing at least one compound selected from the group of compounds represented by formula (3-1) to (3-5) as a third component:

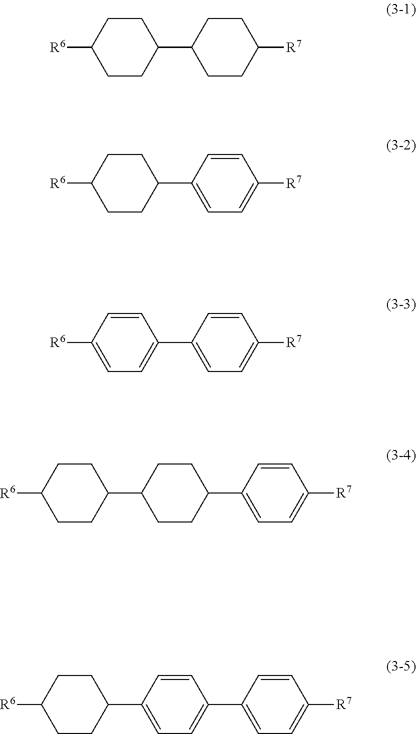

wherein, R⁶ and R⁷ are independently alkyl having 1 to 5 carbons or alkenyl having 2 to 5 carbons.

Item 4. The liquid crystal composition according to item 3, wherein a proportion of the first component is in the range of 50% by weight to 95% by weight, a proportion of the second component is in the range of 5% by weight to 40% by weight, and a proportion of the third component is in the range of 5% by weight to 30% by weight.

Item 5. The liquid crystal composition according to any one of items 1 to 4, wherein a fourth component is at least one compound selected from the group of compounds represented by formula (5):

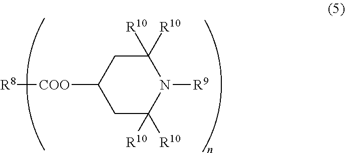

wherein, R⁸ is an alkyl having 1 to 8 carbons or alkenyl having 2 to 8 carbons, R⁹ is alkyl having 1 to 5 carbons, alkoxy having 1 to 5 carbons or hydrogen, R¹⁰ is alkyl having 1 to 5 carbons, and n is 1, 2, 3 or 4.

Item 6. The liquid crystal composition according to item 5, wherein a proportion of the first component is in the range of 50% by weight to 95% by weight, a proportion of the second component is in the range of 5% by weight to 40% by weight, a proportion of the third component is in the range of 5% by weight to 30% by weight, and a proportion of the fourth component is in the range of 0.001% by weight to 5% by weight.

Item 7. The liquid crystal composition according to any one of items 1 to 6, wherein a maximum temperatures of a nematic phase is 70° C. or higher, optical anisotropy (25° C.) at a wavelength of 589 nanometers is in the range of 0.16 to 0.24, dielectric anisotropy at 1 kHz is in the range of 4.0 to 20.0, and dielectric anisotropy at 20 GHz is in the range of 0.3 to 2.0.

Item 8. A millimeter wave phase or microwave phase antenna, including the liquid crystal composition according to any one of items 1 to 7.

The additive that may be added to the composition will be described. Specific examples of such an additive include an optically active compound, a dye, an antioxidant and an ultraviolet light absorber. The optically active compound is mixed with the composition for the purpose of inducing a helical structure in a liquid crystal to give a twist angle. Specific examples of such a compound include compound (6-1) to compound (6-4) . A preferred proportion of the optically active compound is about 5% by weight or less. A further preferred proportion is in the range of about 0.01% to about 2%.

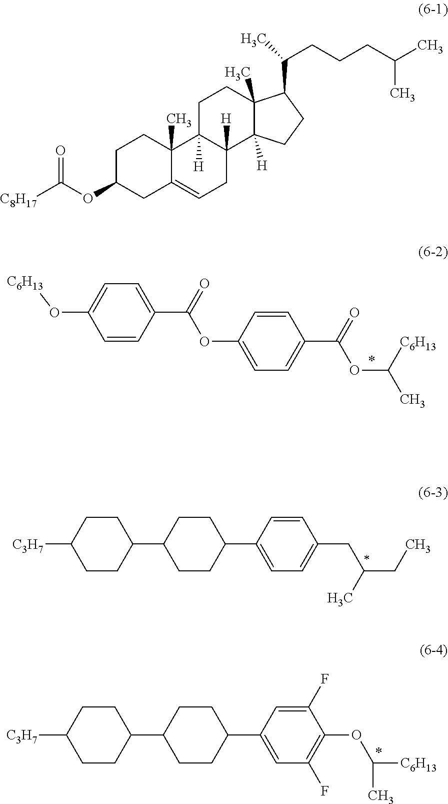

The antioxidant is mixed with the composition for maintaining reliability when the device has been used for a long period of time. A preferred proportion of the antioxidant is about 50 ppm or more for achieving an effect thereof, and about 600 ppm or less for avoiding a decrease in the maximum temperature or an increase in the minimum temperature. A further preferred proportion is about 100 ppm to about 300 ppm.

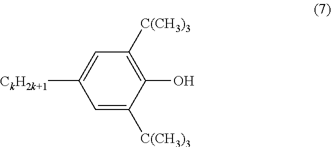

Preferred examples of the antioxidant include compound (7) where k is an integer from 1 to 9, or the like. In compound (5), preferred k is 1, 3, 5, 7 or 9. Further preferred k is 1 or 7. Compound (7) where k is 1 has large volatility, and therefore is effective when preventing a decrease in the specific resistance caused by heating in air. Compound (7) where k is 7 has small volatility, and therefore is effective in maintaining the reliability at room temperature and also at a comparatively high temperature after the high frequency antenna has been used for a long period of time.

Specific preferred examples of the ultraviolet light absorber include a benzophenone derivative, a benzoate derivative and a triazole derivative. A preferred proportion of the ultraviolet light absorber is about 50 ppm or more for achieving an effect thereof, and about 10,000 ppm or less for avoiding a decrease in the maximum temperature or an increase in the minimum temperature. A further preferred proportion is in the range of about 100 ppm to about 1000 ppm.

Last, an application of the composition will be described. Most of the compositions have a minimum temperature of about −10° C. or lower, a maximum temperature of about 70° C. or higher, and optical anisotropy in the range of about 0.16 to about 0.25. The composition can be used as the composition having the nematic phase, and as an optically active composition by adding the optically active compound.

A dielectric constant of a dielectric such as the liquid crystal changes depending on a frequency or a temperature. Therefore, frequency dependence of the dielectric constant is called dielectric characteristics of the dielectric. When an alternating current electric field is applied to the liquid crystal, an internal electric dipole becomes unable to follow a change in the electric field in association with an increase in a frequency f, and therefore a dielectric constant ε′ is decreased, and simultaneously electrical conductivity σ′ is increased and a dielectric loss s″ exhibits a peak in several case. The above phenomenon is dielectric relaxation.

In a microwave or millimeter wave region, a method of attaching a device or a sample is completely different depending on a frequency region to be measured. In a region to 10 GHz, for the reason of easy analysis of an electromagnetic field, a cell of an open end coaxial type is used for a probe, and a measuring system centering on a network analyzer is assembled in many cases, and a spectrum (dielectric relaxation spectrum) of a complex dielectric constant of the sample is obtained by sweeping the frequency. In a region of several tens of GHz or more, a wave guide needs to be used in place of a coaxial cable. For calculation of the dielectric constant, boundary conditions when the electromagnetic wave enters the sample need to be exactly determined, and if a wavelength becomes shorter, more precise processing is required by a decrement thereof. In a low frequency region, a cell to be a capacitor is prepared, and the sample is inserted into the cell, and the dielectric constant is determined from a change in capacitance.

The frequency dependence of the dielectric constant is caused because the electric dipole becomes unable to follow a change in the electric field in association with an increase in the frequency of the alternating current electric field applied to the liquid crystal. Therefore, as the number of rings of a constituent component is smaller, such a case is further advantageous. In addition, as the number of carbons in an alkyl group or an alkenyl group at a terminal is smaller, such a case is further advantageous in several cases, but the constituent component is appropriately selected depending on a restriction of a temperature range in which the device can be used. An alkoxy group or an alkenyloxy group at the terminal may occasionally increase tan 5 in comparison with the alkyl group or the alkenyl group, and therefore an attempt to increase an amount thereof is not preferred.

### EXAMPLES

The invention will be described in detail by way of Examples. The invention is not limited by Examples described below. Compounds in Comparative Examples and Examples were represented using symbols according to definitions in Table I described below. In Table 1, a configuration with regard to 1,4-cyclohexylene and 1,3-dioxane-2,5-diyl is trans. A configuration with regard to a bonding group of —CH═CH— is trans . A parenthesized number next to a symbolized compound in Examples corresponds to the number of the preferred compound. A symbol (−) means any other liquid crystal compound. A proportion (percentage) of the liquid crystal compound is expressed in terms of weight percent (% by weight) based on the total weight of the liquid crystal compound. Values of the characteristics of the composition were summarized in a last part.

TABLE 1
Method for description of compounds using symbols
R—(A₁)—Z₁— . . . —Zₙ—(Aₙ)—X

| 1) Left-terminal group R— | Symbol |
|---|---|
| CₙH₂ₙ₊₁— | n- |
| CₙH₂ₙ₊₁O— | nO— |
| CₙH₂ₙ₊₁OCₘH₂ₘ— | nOm- |
| CH₂═CH— | V— |
| CH₂═CHCₙH₂ₙ— | Vn- |
| CₙH₂ₙ₊₁CH═CHCₘH₂ₘ— | nVm- |
| CₙH₂ₙ₊₁CH═CHCₘH₂ₘCH═CₖH₂ₖ— | nVmVk- |
| CF₂═CH— | VFF- |
| CF₂═CHCₙH₂ₙ— | VFFn- |
| 2) Ring structure —Aₙ— | Symbol |
| 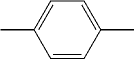 | B |
| 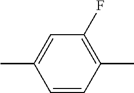 | B(F) |
| 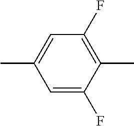 | B(F,F) |
| 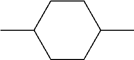 | H |
| 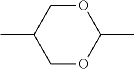 | G |
| 3) Bonding group —Zₙ— | Symbol |
| —C₂H₄— | 2 |
| —C₄H₈— | 4 |
| —COO— | E |
| —C≡C— | T |
| —CH═CH— | V |
| —CF₂O— | CF2O |
| —C₂H₄CF₂O— | 2CF2O |
| 4) Right-terminal group —X | Symbol |
| —F | —F |
| —Cl | —CL |
| —CN | —C |
| —CF₃ | —CF3 |
| —OCF₃ | —OCF3 |
| —OCF₂H | —OCF2H |
| —CₙH₂ₙ₊₁ | -n |
| —OCₙH₂ₙ₊₁ | —On |
| —COOCH₃ | —EMe |
| —CH═CH₂ | —V |
| —CₙH₂ₙCH═CH₂ | -nV |
| —CₘH₂ₘCH═CH₂CₙH₂ₙ₊₁ | -mVn |
| —CH═CF₂ | —VFF |
| —CₙH₂ₙCH═CF₂ | -nVFF |

5) Examples of description
Example 1 3-HB(F)TB-3

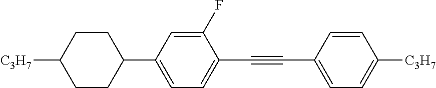

Example 2 3-HB(F)—C

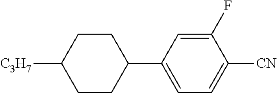

Example 3 3-HBB(F)B-2

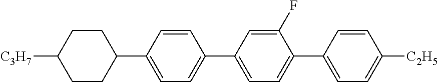

A composition is prepared by measuring weight of components such as a liquid crystal compound, and then mixing the components. Accordingly, calculation of % by weight of the component is easy. However, correct calculation of a proportion of the component by applying gas chromatographic analysis to the composition is not easy. The reason is that a correction coefficient depends on a kind of the liquid crystal compound. Fortunately, the correction coefficient is about 1. Further, a difference of 1% by weight in a component compound has a small influence on characteristics of the composition. Accordingly, in the invention, an area ratio of component peaks in gas chromatograph can be regarded as % by weight of the component compound. More specifically, results of the gas chromatographic analysis (the area ratio of the peaks) may be considered to be equivalent to % by weight of the liquid crystal compound without correction.

When a sample was a composition, measurement was carried out as is, and values obtained were described. When a sample was a compound, the sample was prepared by mixing 15% by weight of the compound and 85% by weight of a base liquid crystal. Values of characteristics of the compound were calculated, according to an extrapolation method, using values obtained by measurement. (Extrapolated value)={(measured value of a sample for measurement)−0.85×(measured value of a base liquid crystal)}/0.15. When a smectic phase (or crystals) precipitates at the ratio thereof at 25° C., a ratio of the compound to the base liquid crystal was changed step by step in the order of (10% by weight: 90% by weight), (5% by weight: 95% by weight) and (1% by weight: 99% by weight). Values of maximum temperature, optical anisotropy, viscosity and dielectric anisotropy with regard to the compound were determined according to the extrapolation method.

A composition of the base liquid crystal is as described below.

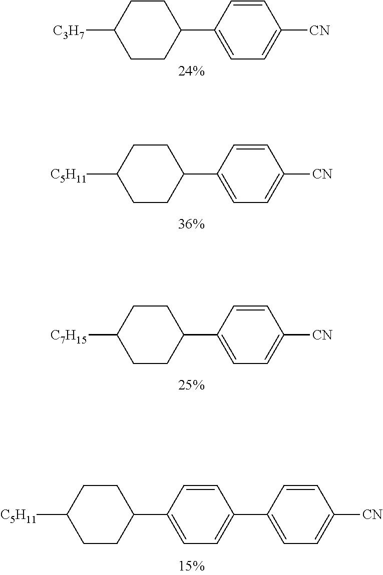

Values of characteristics were measured according to methods described below. Most of the methods are described in Standard of Electric Industries Association of Japan (EIAJ ED-2521B), or modified thereon. No thin film transistor (TFT) was attached to a TN device used for measurement.

Maximum temperature of a nematic phase (NI; ° C.): A sample was placed on a hot plate in a melting point apparatus equipped with a polarizing microscope, and heated at a rate of 1° C. per minute. Temperature when part of the sample began to change from a nematic phase to an isotropic liquid was measured. A maximum temperature of the nematic phase may be occasionally abbreviated as “maximum temperature.”

Minimum temperature of a nematic phase (T_{C}; ° C.): Samples each having a nematic phase were put in glass vials and kept in freezers at temperatures of 0° C., −10° C., −20° C., −30° C. and −40° C. for 10 days, and then liquid crystal phases were observed. For example, when the sample was maintained in the nematic phase at −20° C. and changed to crystals or a smectic phase at −30° C., Tc was expressed as T_{C}≤20° C. A minimum temperature of the nematic phase may be occasionally abbreviated as “minimum temperature.”

Optical anisotropy (refractive index anisotropy; Δn; measured at 25° C.): Measurement was carried out by an Abbe refractometer with a polarizing plate mounted on an ocular, using light at a wavelength of 589 nanometers. A surface of a main prism was rubbed in one direction, and then a sample was added dropwise onto the main prism. A refractive index (n∥) was measured when a direction of polarized light was in parallel with a direction of rubbing. A refractive index (n⊥) was measured when the direction of polarized light was perpendicular to the direction of rubbing. A value of optical anisotropy was calculated from an equation: Δn=n∥−n⊥.

Dielectric anisotropy (Δε1; measured at a frequency of 1 kHz at 25° C.): A sample was put in a TN device in which a distance (cell gap) between two glass substrates was 9 micrometers and a twist angle was 80 degrees. Sine waves (10 V, 1 kHz) were applied to the device, and after 2 seconds, a dielectric constant (ε∥1) of liquid crystal molecules in a major axis direction was measured. Sine waves (0.5 V, 1 kHz) were applied to the device, and after 2 seconds, a dielectric constant (ε⊥1) of the liquid crystal molecules in a minor axis direction was measured. A value of dielectric anisotropy was calculated from an equation: Δε1=ε∥1∥ε⊥1.

Dielectric anisotropy (Δε2; measured at a frequency of 20 GHz at 25° C.): A liquid crystal was filled in a coaxial line to measure a transmission delay time and an insertion loss. The liquid crystal was sealed between a glass substrate and gland metal to form a liquid crystal layer as a dielectric substrate of a microstrip line, and a thickness of the liquid crystal layer, a conductor line width and a line length were adjusted to 50 micrometers, 100 micrometers and 193 millimeters, respectively. A bias voltage (sine waves at 5 kHz) of a variable delay line was increased from 0 Vpp to 30 Vpp, and measurement was carried out. A dielectric constant of the liquid crystal and a dielectric loss of the liquid crystal were determined from the transmission delay time and the insertion loss, respectively. Here, the bias voltage was applied between a center conductor and an external conductor of the coaxial line to control alignment of the liquid crystals, thereby measuring a dielectric constant ε∥2 when the liquid crystals were in parallel with a microwave electric field, and a dielectric constant ε∥2 when the liquid crystals were perpendicular thereto. A value of dielectric anisotropy was calculated from an equation: Δε2=ε∥2−ε⊥2.

### Comparative Example 1

Example 2 was selected from the composition disclosed in Patent literature No. 1 (JP H6-340878 A). A basis is that the composition contains compound (1-2). Components and characteristics of the composition are described below.

| | | |
|---|---|---|
| 3-HBTB(F,F)-F | (—) | 15% |
| 4-HBTB(F,F)-F | (—) | 15% |
| 3O-BB-C | (—) | 10% |
| 5O-BB-C | (—) | 16% |
| 8O-BB-C | (—) | 14% |
| 5-BB-C | (1-2) | 20% |
| 5-PyB-C | (—) | 10% |

NI = 68.7° C.; T_{c} ≤ −10° C.; Δn = 0.167; Δε1 = 11.3; Δε2 = 0.2.

### Comparative Example 2

Example 1 was selected from the composition disclosed in Patent literature No. 2 (JP H7-300585 A). A basis thereof is that the composition contains compounds (1-1), (1-3) and (2-1). Components and characteristics of the composition are as described below.

| | | |
|---|---|---|
| 2O1-BEB(F)-C | (—) | 10% |
| 1V2-BEB(F,F)-C | (1-3) | 10% |
| 3-HB(F)-C | (1-1) | 5% |
| 3-HB-C | (—) | 8% |
| 3-HHB(F)-C | (—) | 7% |
| 3-HH-4 | (3-1) | 10% |
| 3-HH-O2 | (—) | 5% |
| 2-BTB-O1 | (—) | 10% |
| 3-HHB-1 | (3-4) | 10% |
| 3-HHB-3 | (3-4) | 10% |
| 3-HB(F)TB-2 | (2-1) | 8% |
| 3-HB(F)TB-3 | (2-1) | 7% |

NI = 88.3° C.; T_{c} ≤ 0° C.; Δn = 0.151; Δε1 = 8.7; Δε2 = 0.1.

### Example 1

| | | |
|---|---|---|
| 3-HB(F)-C | (1-1) | 6% |
| 5-BB-C | (1-2) | 51% |
| 7-BB-C | (1-2) | 25% |
| 3-BBB-C | (1-4) | 8% |
| 3-H2BTB-2 | (2-1) | 10% |

NI = 73.3° C.; T_{c} ≤ −10° C.; Δn = 0.223; Δε1 = 12.0; Δε2 = 0.6.

### Example 2

| | | |
|---|---|---|
| 1V2-HEB(F,F)-C | (—) | 6% |
| 5-BB-C | (1-2) | 51% |
| 7-BB-C | (1-2) | 25% |
| 3-BBB-C | (1-4) | 8% |
| 3-BB(F)B-5 | (2-2) | 10% |

NI = 69.8° C.; T_{c} ≤ −10° C.; Δn = 0.224; Δε1 = 15.6; Δε2 = 0.8.

### Example 3

| | | |
|---|---|---|
| 1V2-HEB(F,F)-C | (—) | 6% |
| 5-BB-C | (1-2) | 51% |
| 7-BB-C | (1-2) | 25% |
| 3-BBB-C | (1-4) | 8% |
| 3-HBB(F)B-2 | (2-3) | 5% |
| 5-HBB(F)B-2 | (2-3) | 5% |

NI = 78.1° C.; T_{c} ≤ −10° C.; Δn = 0.229; Δε1 = 15.0; Δε2 = 0.6.

### Example 4

| | | |
|---|---|---|
| 2-HB(F)-C | (1-1) | 6% |
| 5-BB-C | (1-2) | 43% |
| 7-BB-C | (1-2) | 25% |
| 3-BBB-C | (1-4) | 8% |
| 3-H2BTB-2 | (2-1) | 10% |
| 3-HH-4 | (3-1) | 3% |
| 3-BB-1 | (3-3) | 5% |

NI = 70.6° C.; T_{c} ≤ −20° C.; Δn = 0.218; Δε1 = 11.6; Δε2 = 0.5.

### Example 5

| | | |
|---|---|---|
| V2-HEB(F,F)-C | (—) | 6% |
| 5-BB-C | (1-2) | 43% |
| 7-BB-C | (1-2) | 25% |
| 3-BBB-C | (1-4) | 8% |
| 3-HBB(F)B-2 | (2-3) | 5% |
| 5-HBB(F)B-2 | (2-3) | 5% |
| 3-HB-2 | (3-2) | 3% |
| 3-HHB-1 | (3-4) | 5% |

NI = 78.8° C.; T_{c} ≤ −10° C.; Δn = 0.225; Δε1 = 13.9; Δε2 = 0.7.

### Example 6

| | | |
|---|---|---|
| 1V2-BEB(F,F)-C | (1-3) | 6% |
| 5-BB-C | (1-2) | 51% |
| 7-BB-C | (1-2) | 25% |
| 3-BBB-C | (1-4) | 8% |
| 3-HBB(F)B-2 | (2-3) | 5% |
| 5-HBB(F)B-2 | (2-3) | 5% |

NI = 77.9° C.; T_{c} ≤ −10° C.; Δn = 0.229; Δε1 = 15.0; Δε2 = 0.6.

### Example 7

| | | |
|---|---|---|
| V2-BEB(F,F)-C | (1-3) | 6% |
| 5-BB-C | (1-2) | 43% |
| 7-BB-C | (1-2) | 25% |
| 3-BBB-C | (1-4) | 8% |
| 3-HBB(F)B-2 | (2-3) | 5% |
| 5-HBB(F)B-2 | (2-3) | 5% |
| 3-HB-2 | (3-2) | 3% |
| 3-HHB-1 | (3-4) | 5% |

NI = 78.3° C.; T_{c} ≤ −10° C.; Δn = 0.225; Δε1 = 13.9; Δε2 = 0.7.

### Example 8

| | | |
|---|---|---|
| 3-BEB-C | (—) | 6% |
| 5-BB-C | (1-2) | 51% |
| 7-BB-C | (1-2) | 25% |
| 3-BBB-C | (1-4) | 8% |
| 3-H2BTB-2 | (2-1) | 10% |

NI = 73.8° C.; T_{c} ≤ −10° C.; Δn = 0.228; Δε1 = 12.3; Δε2 = 0.6.

### Example 9

| | | |
|---|---|---|
| 5-BB-C | (1-2) | 49% |
| 7-BB-C | (1-2) | 25% |
| 6O-BB-C | (—) | 2% |
| 8O-BB-C | (—) | 6% |
| 3-BBB-C | (1-4) | 8% |
| 3-H2BTB-2 | (2-1) | 10% |

NI = 72.1° C.; T_{c} ≤ −20° C.; Δn = 0.226; Δε1 = 11.6; Δε2 = 0.4.

### INDUSTRIAL APPLICABILITY

A liquid crystal compound according to the invention can be used in the form of a millimeter wave phase or microwave phase antenna.

What is claimed is:

1. A liquid crystal composition for a millimeter wave phase or microwave phase antenna, having a nematic phase, and containing at least two compounds selected from the group of compounds represented by formula (1-1) to formula (1-4) as a first component, wherein at least one compound selected from the compounds represented by formula (1-1) and at least one compound selected from the compounds represented by formula (1-3) are not simultaneously selected, and at least one compound selected from the group of compounds represented by formula (2-1) to formula (2-3) as a second component: 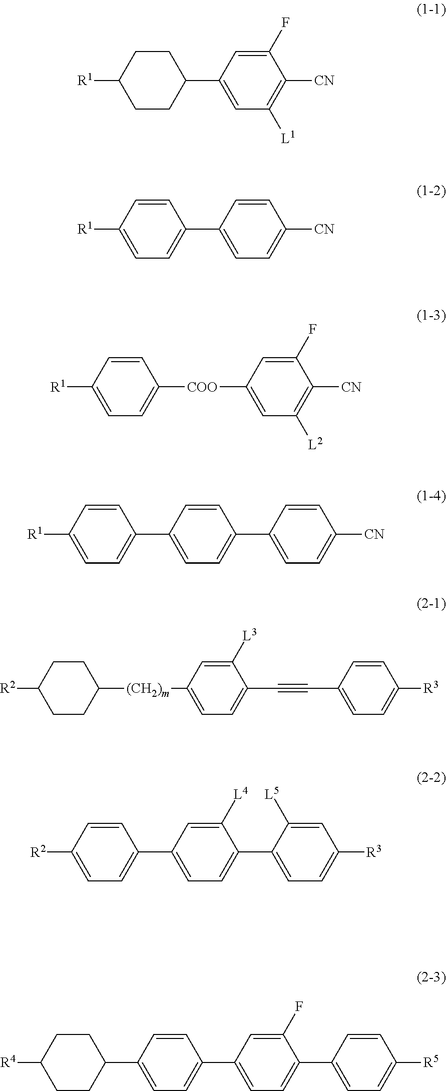
wherein, R¹, R², R³, R⁴ and R⁵ are independently alkyl having 1 to 7 carbons or alkenyl having 2 to 7 carbons, and L¹, L², L³, L⁴ and L⁵ are independently hydrogen or fluorine, and m is 0 or 2, in which one of L⁴ and L⁵ is fluorine, and the other is hydrogen.

2. The liquid crystal composition according to claim 1, wherein a proportion of the first component is in the range of 50% by weight to 95% by weight, and a proportion of the second component is in the range of 5% by weight to 50% by weight.

3. The liquid crystal composition according to claim 1, containing at least one compound selected from the group of compounds represented by formula (3-1) to (3-5) as a third component: 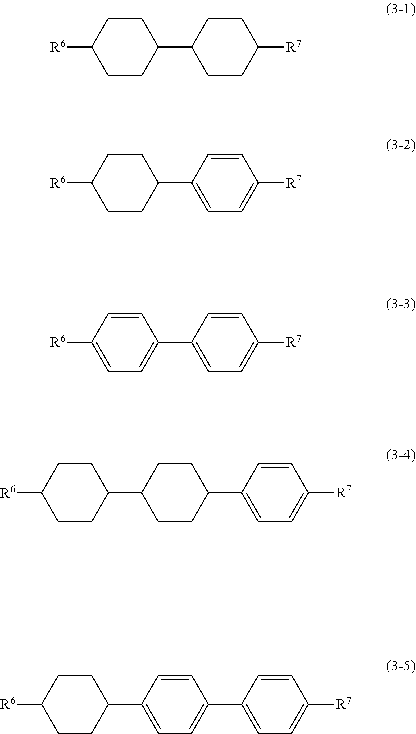
wherein, R⁶ and R⁷ are independently alkyl having 1 to 5 carbons or alkenyl having 2 to 5 carbons.

4. The liquid crystal composition according to claim 3, wherein a proportion of the first component is in the range of 50% by weight to 95% by weight, a proportion of the second component is in the range of 5% by weight to 40% by weight, and a proportion of the third component is in the range of 5% by weight to 30% by weight.

5. The liquid crystal composition according to claim 1, containing at least one compound selected from the group of compounds represented by formula (5) as a fourth component: 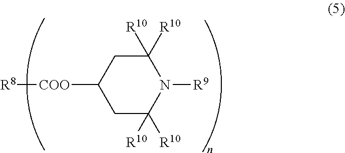
wherein, R⁸ is alkyl having 1 to 8 carbons or alkenyl having 2 to 8 carbons, R⁹ is alkyl having 1 to 5 carbons, alkoxy having 1 to 5 carbons or hydrogen, R¹⁰ is alkyl having 1 to 5 carbons, and n is 1, 2, 3 or 4.

6. The liquid crystal composition according to claim 3, containing at least one compound selected from the group of compounds represented by formula (5) as a fourth component: 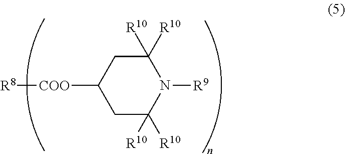
wherein, R⁸ is alkyl having 1 to 8 carbons or alkenyl having 2 to 8 carbons, R⁹ is alkyl having 1 to 5 carbons, alkoxy having 1 to 5 carbons or hydrogen, R¹° is alkyl having 1 to 5 carbons, and n is 1, 2, 3 or 4.

7. The liquid crystal composition according to claim 6, wherein a proportion of the first component is in the range of 50% by weight to 95% by weight, a proportion of the second component is in the range of 5% by weight to 40% by weight, a proportion of the third component is in the range of 5% by weight to 30% by weight, and a proportion of the fourth component is in the range of 0.001% by weight to 5% by weight.

8. The liquid crystal composition according to claim 1, wherein a maximum temperatures of a nematic phase is 70° C. or higher, optical anisotropy (25° C.) at a wavelength of 589 nanometers is in the range of 0.16 to 0.25, dielectric anisotropy at 1 kHz is in the range of 4.0 to 20.0, and dielectric anisotropy at 20 GHz is in the range of 0.3 to 3.0.

9. The liquid crystal composition according to claim 3, wherein a maximum temperatures of a nematic phase is 70° C. or higher, optical anisotropy (25° C.) at a wavelength of 589 nanometers is in the range of 0.16 to 0.25, dielectric anisotropy at 1 kHz is in the range of 4.0 to 20.0, and dielectric anisotropy at 20 GHz is in the range of 0.3 to 3.0.

10. A millimeter wave phase or microwave phase antenna, including the liquid crystal composition according to claim 1.

11. A millimeter wave phase or microwave phase antenna, including the liquid crystal composition according to claim 3.
